(19) United States
(12) Patent Application Publication
(10) Pub. No.: US 2021/0372082 A1
(43) Pub. Date: Dec. 2, 2021

(54) Towable Attachment Leveling Assembly

(71) Applicant: G2 Turftools, Inc., Athens, AL (US)

(72) Inventor: Eric L. Merkt, Athens, AL (US)

(73) Assignee: G2 Turftools, Inc.

(21) Appl. No.: 17/328,367

(22) Filed: May 24, 2021

Related U.S. Application Data
(60) Provisional application No. 63/033,324, filed on Jun. 2, 2020.

(51) Int. Cl. E02F 3/84; E02F 3/815; A01G 20/35

(52) U.S. Cl. CPC E02F 3/842; A01G 20/35; E02F 3/8155

(57) ABSTRACT

A towable attachment leveling apparatus, typically used on tractors, skid-steer, and other vehicles, with ability to independently vary the inclination of each side of an attachment, such as a turf box, about a centerline axis running substantially parallel to the longitudinal direction of travel during use, as well as adjust the vertical elevation of the attachment and allow for additional adjustments to the pitch and/or yaw of the attachment.

### CROSS-REFERENCE TO RELATED APPLICATIONS

The present invention claims priority to pending U.S. Provisional Patent Application No. 63/033,324, filed Jun. 2, 2020, incorporated herein by reference in its entirety.

### FIELD OF THE DISCLOSURE

The disclosure relates generally to a leveling apparatus and systems typically used on tractors, skid-steer, and other vehicles. The present invention has the ability to independently vary the inclination of each side of an apparatus, such as a turf box, about a centerline axis running substantially parallel to the longitudinal direction of travel during use, as well as adjusting the vertical elevation of the attachment and allowing for additional adjustments to the pitch and/or yaw of the attachment.

### BACKGROUND OF THE DISCLOSURE

The present invention relates to levelers, a device typically attached to tractors, excavators, and skid-steer vehicles for the purpose of leveling, smoothing or contouring the ground. It is envisaged however that the present invention may find other uses, and be adapted therefore.

Levelers and other apparati for leveling, smoothing and contouring ground take many shapes and designs, including those which are merely dragged along the ground. Many, however, have blades, sometimes known as mould boards, box blades, or turf boxes, for leveling and altering the contour of the ground. Some devices, such as turf planers, have cutting elements which allow soil to be removed, such as by trucks, as detailed in U.S. Pat. Nos. 9,198,339; 8,555,992 and 7,992,649 and U.S. Publ. Appl. Nos. 20180271017 and 20190257058 which are all incorporated herein by reference. In these versions, the height of the blade is typically able to be altered, which allows the user control over grading, leveling and/or sculpting the contour of the ground. Elevation adjustment is sometimes achieved by raising the entire leveling assembly, while others may rely on merely raising and lowering a portion with the blade.

For agricultural applications, generally the contour of the land needs merely to be smoothed. However, levelers have found use in construction sites and sports fields where they are commonly used to level large areas for foundations, infields, and similar surfaces. Here the leveling needs to be precisely, and truly horizontal. Alternatively, the desire may be to contour a large area to allow for drainage such as on an athletic field. Achieving this requires operator skill, and patience. Wheeled versions tend to be most popular as merely raising and lowering the blade, as opposed to the entire leveling assembly, is quicker and more precise, enabling quick responses. When coupled with a laser leveling system, adjusting only the blade elevation allows the operator to work much more quickly.

In many instances, not only must the blade elevation be altered but so too must its inclination, referred to herein as pitch, relative to the tractor/skid steer to ensure that it is always at true horizontal. If the tractor unit traverses a slope, a fixed inclination blade will level the ground at the same inclination as the tractor unit is. This makes leveling mounds and slopes to the true horizontal extremely difficult.

To address this, the prior art uses leveler attachment arrangements (typically referred to as Quick-Hitch) which include an arrangement for varying the inclination of the attachment. These rotational arrangements are expensive, and also add considerable weight to the load carried by the towing unit. They are also limited in the degree of precision with respect to inclination (pitch) to a particular angle, and relatively slow to adjust. This slows any leveling operation.

Accordingly, the inventor has identified a need for a leveling unit, which can address the above issues, and at least provide a blade portion able to be adjusted in elevation, and inclination (pitch), and which can be towed.

In some situations, ground preparation work needs to be performed before leveling and grading can occur. In practice this involves working the ground/site with a different implement. For example, where a site is covered with grass or weed, something such as what is commonly known as a “Harley Rake” may be used, which is essentially a powered rotating drum rake. The radially protruding tines on the powered rotating rake penetrate through the upper layer of the ground, to effectively break up thatch, matted plant material, compacted soil, and even light surface coverings such as bitumen. Without this prior treatment the blade tends to skid across the surface of the ground.

In more difficult situations a fixed rake with downward ground penetrating tines may be used to break up harder ground, or where foreign objects which may damage a Harley rake may be present. This solution is more likely to be used on old construction and demolition sites, or where harder man-made coverings of asphalt and bitumen may be present. Again, preparing the ground prior to subsequent operation with a blade assembly allows more effective leveling to be performed.

Prior art devices require that the ground must be worked more than once—first with a ground preparing tool, and then the leveling/contouring operation. If the operator has two machines, then one can be preparing the ground while the leveler follows. The disadvantages of these techniques is the extra cost for more tools, the extra time of multiple operations, and the extra cost if more than one tractor is used. These represent significant disadvantages in terms of time and capital expense. It would therefore be a significant advantage to the ground-working and construction industries if these disadvantages could at least be partially addressed.

Also, more and more operators are using laser guidance systems for controlling their attached implements. The additional speed and accuracy of laser assisted guidance is making it almost a necessity for operators to remain competitive and meet accelerated timeframe expectations required on many jobs. The downside is that such systems are an expensive investment, and usually they are only implemented on a blade implement, and not on other accessories as well. However, there is still an advantage if accessories performing ground preparation work are also able to be controlled by laser guided assistance systems. Apart from reducing the work required by a subsequent blade operation, there are some instances where significant advantage may be obtained.

One such instance is in roadway repair and construction, and by roadway we include paths, sidewalks, carparks, and similar sealed areas. Quite often minimal and subtle grading is required (more for water runoff requirements), and being able to use a laser assisted power rake to prepare sublayers for final application of concrete or asphalt can be advantageous. It would therefore be of advantage to the roading, groundworking, and construction industries at least, if the additional cost of adding laser guided control systems to individual ground-working accessories could be addressed.

It is also useful for some applications to not only be able to modify the roll characteristics of a blade or accessory, but sometimes also the pitch and/or yaw (see FIG. 1). This can be dictated by a number of factors, including the terrain and materials being worked, but is sometimes useful. It would therefore be useful if a leveler could be controlled to provide for adjustments in either or both pitch and roll as well according to user and operator choice.

### BRIEF DESCRIPTION OF THE DISCLOSURE

This disclosure relates to an attachment leveling assembly, transport pivot axle assembly, and wheel assembly in which the transport pivot axle is pivotally mounted and controlled for compensating for all types of variations and unevenness in a ground surface. An improved attachment wheel support, in the wheel assembly, pivots, within constraints, about a generally longitudinally extending axis.

An attachment leveling assembly has a transport pivot axle assembly, at least two wheel assemblies, and a towable attachment assembly. The transport pivot axle assembly is rotatably attached to the towable attachment assembly. The transport pivot axle has at least two transport axle portions configured to independently rotate about a lateral axis in response to motion of at least two independently operated hydraulic cylinders extending between the towable attachment assembly and the at least two transport axle portions. At least two wheel assemblies, wherein each wheel assembly is removably and rotatably attached to one of the at least two transport axle portions, and the at least two wheel assemblies are configured to independently rotate about a longitudinal axis, within restraint limits, in response to ground contact and rotation of the transport axle assembly. The at least two independently operated hydraulic cylinders are configured to respond to control signals from an attachment leveling assembly control system.

These and other features, aspects and advantages of the present disclosure will become better understood with reference to the following description and appended claims. The accompanying drawings, which are incorporated in and constitute a non-limiting part of this specification, illustrate embodiments of the disclosure and, together with the description, serve to explain the principles of the disclosure.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 illustrates an isometric view of one embodiment of the leveling attachment, which can be towed by a vehicle.

FIG. 2 illustrates an exploded view of one embodiment of the leveling attachment.

FIG. 3 illustrates a top view of one embodiment of the transport axle assembly and wheel assembly.

FIG. 4 illustrates an isometric view of one embodiment of the wheel assembly.

FIG. 5 illustrates components of an embodiment of the wheel assembly pivot restraint.

FIG. 6 illustrates multiple views of the attachment leveling assembly without laser masts.

FIG. 7 illustrates multiple views of the attachment leveling assembly with laser masts.

FIG. 8 illustrates an isometric view of the transport pivot axle and wheel assembly with hydraulic cylinders.

FIG. 9 illustrates multiple views of an embodiment of the invention with control devices.

Repeat use of reference characters in the present specification and drawings is intended to represent the same or analogous features or elements of the present disclosure.

### DETAILED DESCRIPTION OF THE DISCLOSURE

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Each example is provided by way of explanation of the disclosure, not limitation of the disclosure. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

The term “proximate” indicates a position on an element that is closest to the vehicle, whereas the term “distal” indicates a position on an element that is furthest away from the vehicle. Dual-headed arrows shown on the figures indicates the ability of a referenced element to change position in a direction generally parallel with the direction of the arrow.

The invention will be described with particular reference to a towable attachment leveling assembly without limit thereto. One of skill in the art would appreciate that the method of control could be utilized with other turf grading or contouring devices. As shown in the figures, the components of the towable attachment leveling assembly include the following:

| Component | |
|---|---|
| Number | Description |
| 100 | Attachment Leveling Assembly |
| 102 | Transport Pivot Axle Assembly |
| 104 | Wheel Assembly |
| 106 | Towable Attachment Assembly |
| 108 | Wheel Pivot Assembly |
| 109 | Wheel Assembly Yoke |
| 110 | Transport Axle Portion |
| 112 | Transport Axle Portion |
| 114 | Pivot Restraint |
| 115 | Wheel Assembly Yoke Sleeve |
| 116 | Wheel Pivot |
| 118 | Axle Pivot Bearing |
| 120 | Hydraulic Transport/Tilt Cylinder |
| 122 | Tandem Wheel Pivot |
| 124 | Adjustable Cylinder Tabs |
| 126 | Replaceable Cutting Edge |
| 128 | Hitch |
| 130 | Tires |
| 132 | Radar Beam |
| 134 | Cut Height |
| 136 | Cut Depth |
| 200 | Laser Receiver |
| 201 | Laser Beam |
| 202 | Proportional Hydraulic Valve |
| 203 | Laser Transmitter |
| 204 | Attachment Leveling Assembly Control System |
| 1000 | Controller Interface |
| 1164 | Autograde Sensor |
| 1196 | Autodepth Sensor |
| 2044 | Slope Sensor |

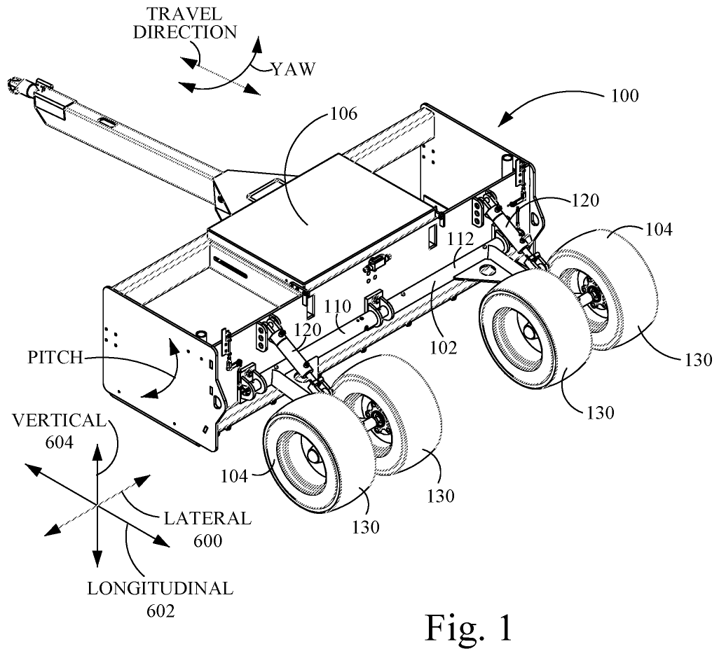

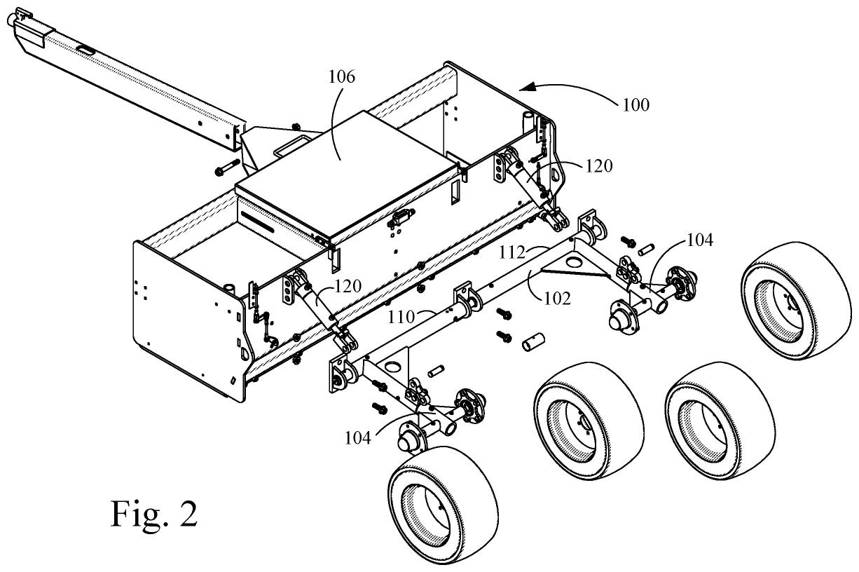

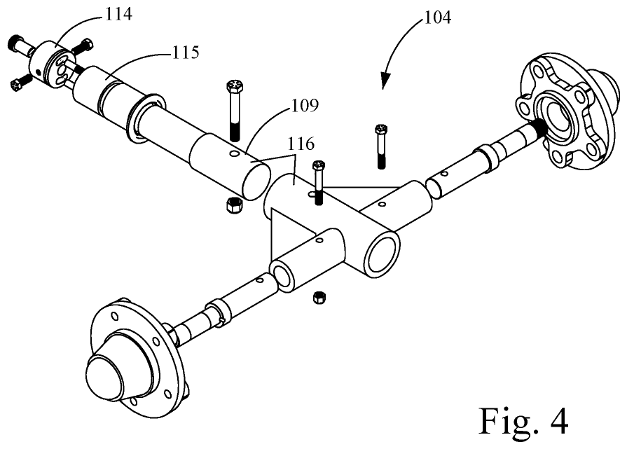

FIG. 1 illustrates an isometric view of one embodiment of the attachment leveling assembly 100, which can be towed by a vehicle. The attachment leveling assembly 100 has a transport pivot axle assembly 102, at least two wheel assemblies 104, and a towable attachment assembly 106. The transport pivot axle assembly 102 is removably and rotatably attached to the towable attachment leveling assembly 100. The transport pivot axle assembly 102 has at least two transport axle portions (110, 112) configured to independently rotate about a lateral axis 600 in response to motion of at least two independently operated hydraulic cylinders 120 extending between the towable attachment assembly 106 and the at least two transport axle portions (110, 112). At least two wheel assemblies 104 are removably and rotatably attached to the at least two transport axle portions (110, 112), and the at least two wheel assemblies 104 are configured to independently rotate about a longitudinal axis 602, within restraint limits imposed by pivot restraint 114 (see FIG. 4), in response to ground contact and rotation of the transport axle assembly 102. The at least two independently operated hydraulic cylinders 120 are configured to respond to control signals from an attachment leveling assembly control system 204, typically using laser receiver 200 capable of receive a laser beam, 201, from a laser transmitter, 203. FIG. 2 illustrates an exploded view of the same embodiment of the leveling attachment assembly 100. FIG. 2 illustrates an exploded view of the attachment leveling assembly 100.

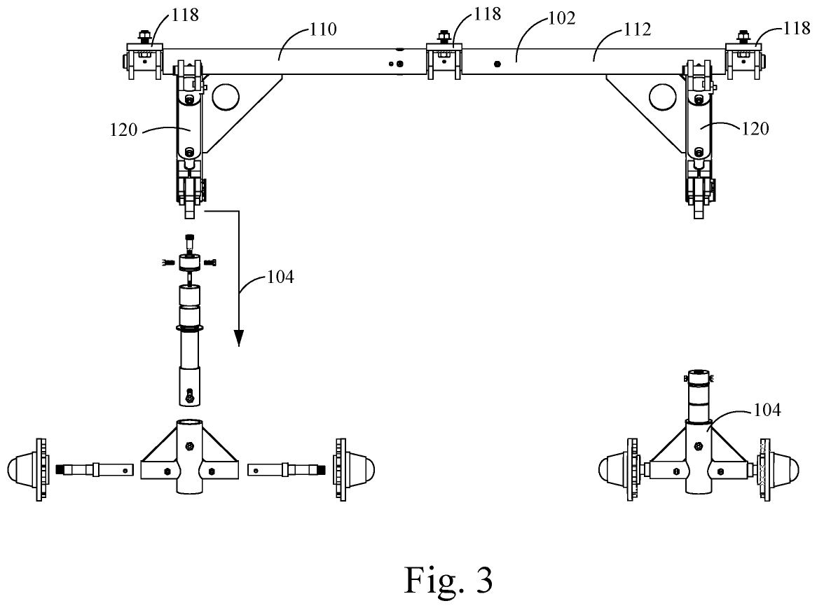

FIG. 3 illustrates a top view of one embodiment of the transport axle assembly 102 and two wheel assemblies 104. As shown, two transport axle portions (110, 112) are configured to independently rotate about a lateral axis 600 in response to motion of at least two independently operated hydraulic cylinders 120 extending between the towable attachment assembly 106 and the two transport axle portions (110, 112).

FIG. 4 illustrates an isometric view of one embodiment of a wheel assembly 104. The wheel assembly yoke 109 freely rotates inside the wheel assembly yoke sleeve 115 until it reaches the limits of the pivot restraint 114. This allows the wheel assembly 104 to easily recover from loss of ground contact and prevent relative positional binding of the at least two wheel assemblies 104.

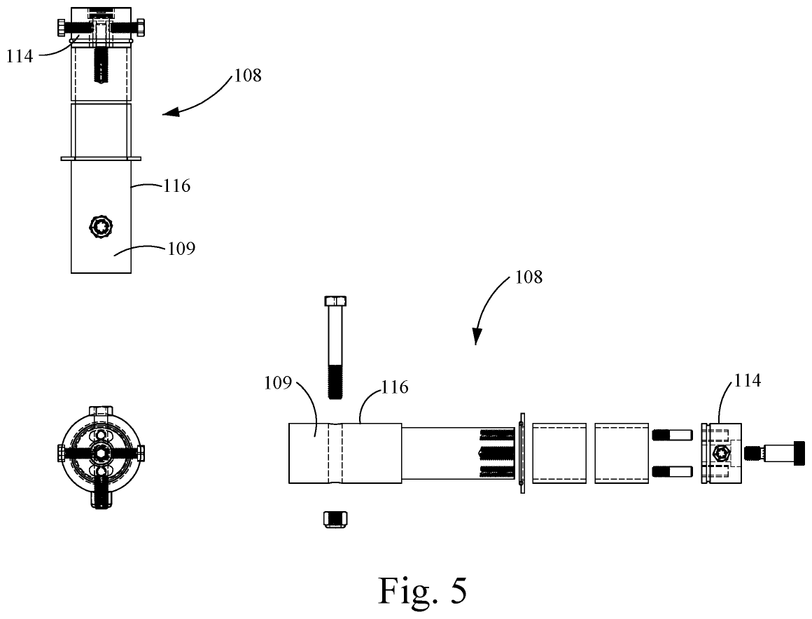

FIG. 5 illustrates components of an embodiment of the wheel assembly 104 pivot restraint 114. The pivot restraint 114 is the part of the wheel pivot assembly 108 that prevents each wheel assembly yoke 109 from over-rotating around the wheel assembly yoke 109 center axis, thereby allowing the wheel assembly 104 to easily recover from loss of ground contact and prevent relative positional binding of the at least two wheel assemblies 104. Typically, the pivot restraint 114 allows free rotation of each wheel assembly 104 in the pivot range of about ±10 degrees from vertical. The pivot restraint 114 pivot range is adjustable, typically by a stop mechanism configured to vary the stop position at the pivot restraint limits.

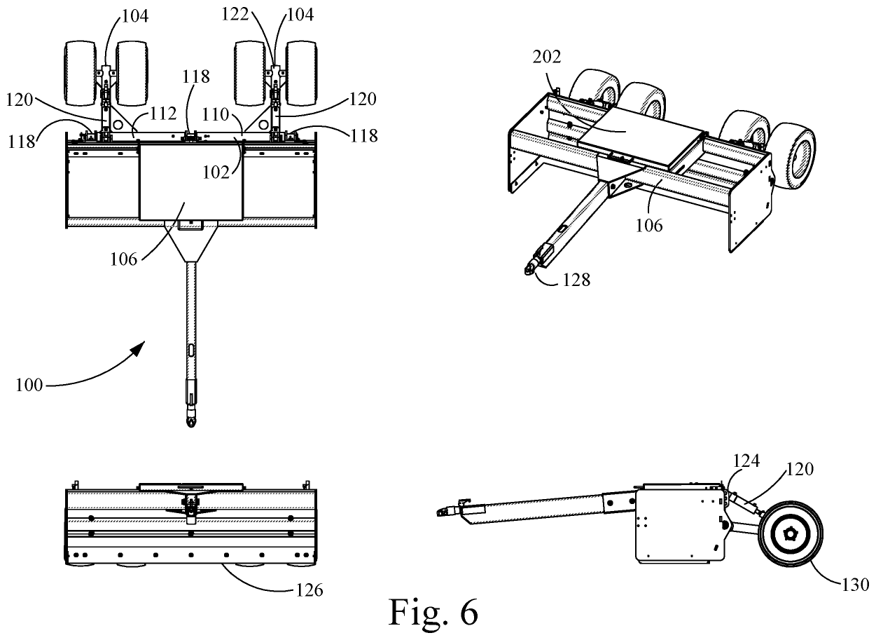

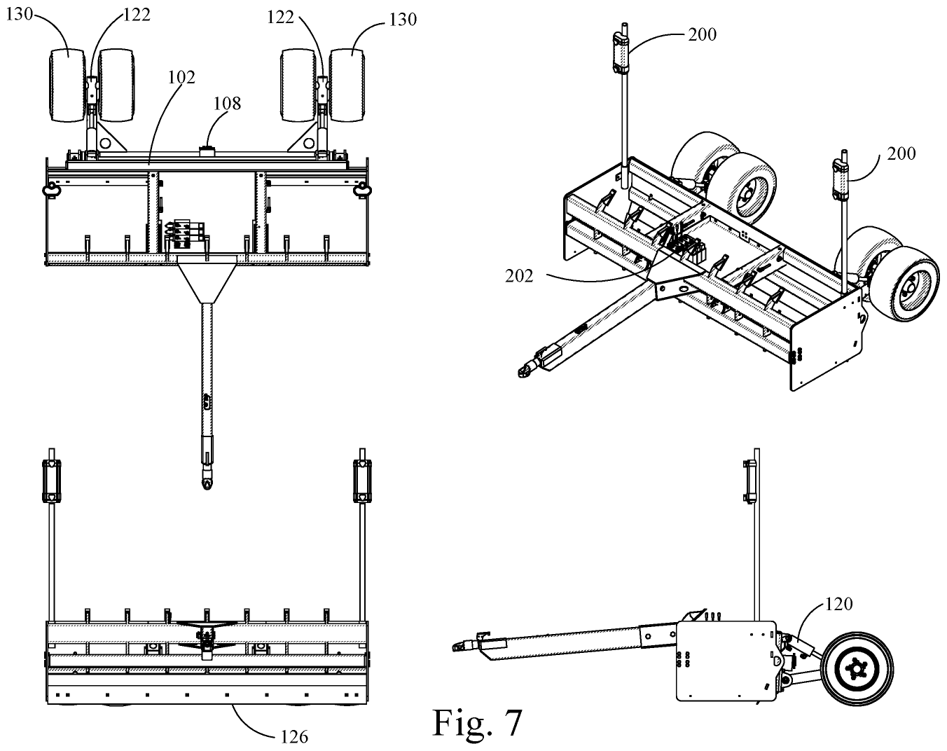

FIG. 6 illustrates multiple views of the attachment leveling assembly 100 without laser masts used as part of the laser control system. Dual proportional control valves 202 independently control each hydraulic transport/tilt cylinder 120 in response to the attachment leveling assembly control system, thereby independently lifting and dropping each transport axle section (110, 112). FIG. 7 illustrates multiple views of the attachment leveling assembly 100 with laser masts used as part of laser receiver 200 of the attachment leveling assembly control system.

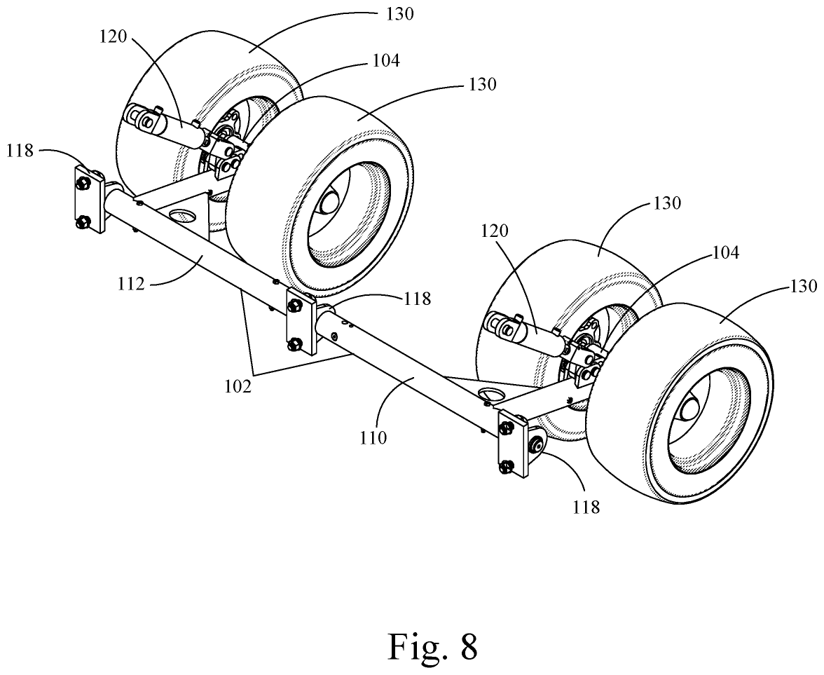

FIG. 8 illustrates an isometric view of the transport pivot axle assembly 102 and wheel assembly 104 with hydraulic cylinders 120 that attach to the towable attachment assembly 106 at adjustable cylinder tabs 124.

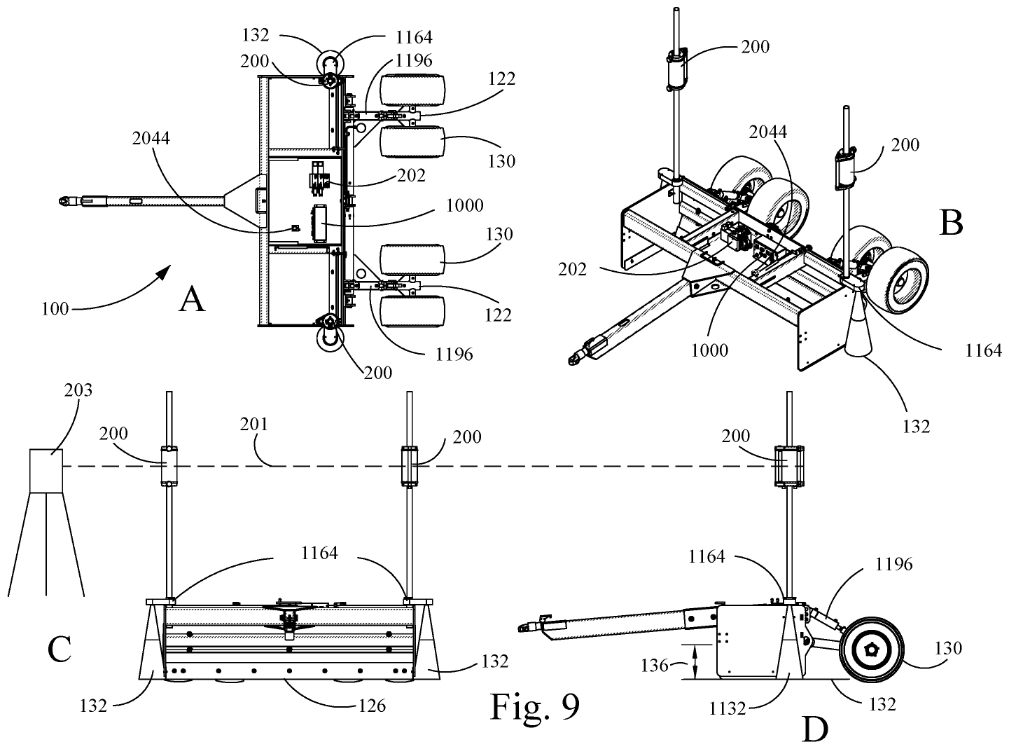

FIG. 9 illustrates embodiments of the invention. FIG. 9A is a top view, FIG. 9B is a top perspective view, FIG. 9C is a front view and FIG. 9D is a left side view. In FIG. 9 a controller interface, 1000, allows for integration of the various sensors with the hydraulic cylinders to provide control of the turf grading equipment as will be described more fully herein.

In FIG. 9 an autograde sensor 1164 determines a distance from the sensor to an adjacent surface thereby allowing the area being graded to match an adjacent surface without a deviation in height in the lateral 600 direction at the junction of the graded area and adjacent surface. A particularly autograde sensor 1164 is a radar sensor which generates a radar beam, 132. It is well known in the art that a radar sensor sends and receives a radar beam 132 with the time difference there between used to calculate the distance which is communicated to a controller as will be further described herein.

Also in FIG. 9, an autodepth sensor 1196 monitors the height of the wheels, 130, relative to the cut of the turf grading equipment, 134. If the cut depth, 136, exceeds a predetermined limit, based on the length of the autodepth sensor 1196, the control system 204 may increase the length of the hydraulic transport/lift cylinder, 120, integrated with the autodepth sensor 1196 to a point sufficient to decrease the cut depth 136. An example autodepth sensor measures a travel length of the hydraulic transport/lift cylinder, 120.

In FIG. 9, a slope sensor, 2044, determines the angle of the turf grading equipment relative to lateral direction 600 (see FIG. 1). The slope sensor 2044 provides a slope to the attachment leveling control system 204. The attachment leveling assembly control system 204 uses input from at least one of the autograde sensor 1164, the autodepth sensor 1196, and the slope sensor 2044 to control the pitch and yaw of the attachment leveling assembly.

This written description uses examples of the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An attachment leveling assembly comprising;
a transport pivot axle assembly removably and rotatably attached to a towable attachment assembly, said transport pivot axle assembly comprising at least two transport axle portions configured to independently rotate about a lateral axis in response to motion of at least two independently operated hydraulic cylinders extending between the towable attachment assembly and the at least two transport axle portions;
at least two wheel assemblies, wherein each wheel assembly is removably and rotatably attached to one of said at least two transport axle portions, said at least two wheel assemblies configured to independently rotate about a longitudinal axis within restraint limits, in response to ground contact and rotation of the transport axle assembly;
wherein said at least two independently operated hydraulic cylinders are configured to respond to control signals from an attachment leveling assembly control system.

2. The attachment leveling assembly of claim 1, wherein the attachment leveling assembly is configured for being towed by a vehicle.

3. The attachment leveling assembly of claim 2, wherein the vehicle comprises at least one of a tractor, excavator, skid-steer, and all-terrain vehicle.

4. The attachment leveling assembly of claim 1, wherein the towable attachment assembly comprises at least one of a mould board, box blade, turf box, and turf planer.

5. The attachment leveling assembly of claim 1, wherein the restraint limits are imposed by at least one pivot restraint disposed on a wheel assembly yoke extending from the at least two wheel assemblies.

6. The attachment leveling assembly of claim 5, wherein the at least one pivot restraint comprises an adjustable stop mechanism configured to vary the stop position at the pivot restraint limits.

7. The attachment leveling assembly of claim 5, wherein the at least one pivot restraint allows free rotation of the wheel assembly within pivot restraint limits in the range of plus or minus 10 degrees from vertical.

8. The attachment leveling assembly of claim 1, further comprising an attachment leveling assembly control system.

9. The attachment leveling assembly of claim 8, wherein the attachment leveling assembly control system comprises at least one laser receiver.

10. The attachment leveling assembly of claim 8, wherein the attachment leveling assembly control system comprises at least one of an autograde sensor, an autodepth sensor, a slope sensor, and combinations thereof.

11. The attachment leveling assembly of claim 10, wherein the autograde sensor comprises a radar beam.
